(19) United States
(12) Patent Application Publication
(10) Pub. No.: US 2008/0146256 A1
(43) Pub. Date: Jun. 19, 2008

(54) SHARING DATA DURING A VOICE CALL USING A MOBILE COMMUNICATIONS DEVICE, AND ASSOCIATED USER INTERFACE

(76) Inventors: Jeffrey Charles Hawkins, Atherton, CA (US); Ryan Case, Sunnyvale, CA (US); Robert Y. Haitani, Menlo Park, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/612,677

(22) Filed: Dec. 19, 2006

(51) Int. Cl. H04Q 7/20; H04M 1/00

(52) U.S. Cl. 455/466; 455/566

(57) ABSTRACT

Mobile communication devices can share data during a voice call, which data ay include documents, media streams, and/or any other information that can be stored on or accessible to the devices. These shared data may be associated with an item currently being accessed on or viewed by one of the mobile communication devices. To share the data from one device to another during a voice call, a data connection is established without interrupting the voice call. A user interface on the mobile communication device may facilitate the selection of the data to share while the voice call is in progress.

### BACKGROUND

The present invention relates to telecommunications, and more specifically, to sharing data between mobile communication devices during a voice conversation between the devices.

Handheld devices and computers are increasingly becoming more powerful and functional devices. Many handheld devices are multifunction devices that have multiple device roles including: personal digital assistant (PDA), cellular phone, portable media player, voice recorder, video recorder, global positioning system (GPS), camera, and electronic file storage. The increased functionality of handheld devices has resulted in the increased use of handheld devices as mobile communication devices.

Mobile communication devices are typically handheld devices that integrate personal information management, electronic file storage, video recording, still image capture, and computing capabilities with cellular phone capabilities in the same device. Examples of mobile communication devices include PDAs with cellular telephone capabilities added, or mobile telephones equipped with computing (“smart”) capabilities, such as PDA functions. In addition to computing and telephone capabilities, it is increasingly common for mobile communication devices to include imaging capabilities such as video recording or still image capture.

The advance of both wireless Internet connections and the computing capabilities of mobile communication devices has allowed the direct transfer of data, such as electronic files, between mobile communication devices. This allows electronic information to be accessible from mobile communication devices in virtually all locations. Thus, mobile communication devices allow electronic information to be more widely disseminated, enabling people in remote locations to collaborate over the same electronic information.

This widespread dissemination of information has created a need for need for multiple people to access simultaneously and comment on particular electronic information. For example, one person may need to observe events at a remote location and comment on those events, as they happen, to a person who is not at the remote location. Alternatively, two people using mobile communication devices engaged in a voice conversation may need to view an electronic copy of a document stored on one of the mobile communication devices being used without disrupting the voice conversation.

Conventional mobile communications devices do not allow for simultaneous transmission of both data and voice information. Rather, existing mobile communications devices require users to make separate connections to transmit electronic or video data, and voice information. Additionally, conventional mobile communication devices further limit the ability to transmit data and voice simultaneously by requiring the user to navigate a series of menus to access and transmit data. Thus, to transmit and then discuss a particular piece of data, existing voice transmissions must be terminated, a data connection established between the devices, the data transmitted, and a new voice transmission initiated.

Therefore, there is a need for a method allowing transmission of electronic data between mobile communication devices without interrupting an established voice connection between the mobile communication devices.

### SUMMARY

Using various embodiments of the invention, a user may communicate data between a local mobile communication device and remote mobile communication device without interrupting an established voice connection between the mobile communication devices. This allows, in certain embodiments, data that may be relevant to a conversation occurring over the voice connection to be transmitted without interruption of that conversation. In particular, the transmitted data may comprise a file or media stream that is being viewed on or otherwise associated with the display of information on the mobile communication device that transmits the data.

In one embodiment of the invention, data are communicated from a local mobile communication device to a remote mobile communication device. A signal is transmitted to establish a voice connection between the local mobile communication device and the remote mobile communication device. Upon receiving a command from a user to communicate data from the local mobile communication device to the remote mobile communication device, the data are transmitted from the local mobile communication device to the remote mobile communication device while maintaining the voice connection. Alternatively, the data connection may be established at other times, such as before the user command is received and possibly when the voice connection is established.

In one embodiment, to transmit data, a signal is transmitted to establish a data connection between the local mobile communication device and the remote mobile communication device. The data is then transmitted from the local mobile communication device to the remote mobile communication device using the established data connection.

In one embodiment, the data communicated from the local to the remote mobile communication device are related to information being accessed on a user interface of the local mobile communication device. For example, the data may comprise a picture or a video stream being captured by a camera within or coupled to the local mobile communication device or some other media stream being viewed on the local device. Sending the data may then comprise sending a media stream from the local mobile communication device to the remote mobile communication device. In another example, the data may comprise a file or other document being viewed, edited, or otherwise accessed on the local mobile communication device. In this case, sending the data may comprise sending the file or other object from the local mobile communication device to the remote mobile communication device.

In one embodiment, a voice network is used to establish the voice connection while a separate data network is used to establish the data connection. Alternatively, a single network may be used to establish both the voice connection and the data connection. In another embodiment, a network server is used to establish the data connection. The local mobile communication device requests a network address identifying the remote mobile communication device from the network server. Once the local mobile communication device receives the network address of the remote mobile communication device from the network server, the local mobile communication device accesses the remote mobile communication device using the network address received from the network server.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1 is a diagram of an architecture of the system, according to one embodiment of the invention.

FIG. 2 is a flow chart of a process for transmitting data to a remote mobile communication device during a voice call, according to one embodiment of the invention.

FIG. 3 is a block diagram of a network configuration according to one embodiment of the invention.

FIG. 4 is a trace diagram illustrating the establishment of a data connection between mobile communication devices, according to one embodiment of the invention.

FIG. 5 is a diagram of an architecture of the system, according to one embodiment of the invention.

FIG. 6 is an example user interface for sharing a file, according to one embodiment of the invention.

FIG. 7 is an example user interface for sharing a media stream, according to one embodiment of the invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

### DETAILED DESCRIPTION

Embodiments of the invention allow users to share electronic information between mobile communication devices while using the mobile communication devices to conduct a voice conversation. While conducting a voice conversation on the mobile communication device, a person may wish to share data on the mobile communication device, such as a file, a video, or a picture. The mobile communication device may then be used to share the data without interrupting the voice conversation. This allows the person to cause the selected data to appear on a remote multiple mobile communication device, enabling the user to share data with a user of another connected mobile communication device while engaged in a voice conversation and without interrupting that conversation. Since the data accessed on a device during a voice call is likely data to be relevant to that voice call (and thus likely to be data that a user may wish to share with the other party), a user interface may be provided to facilitate this data sharing.

### System Architecture

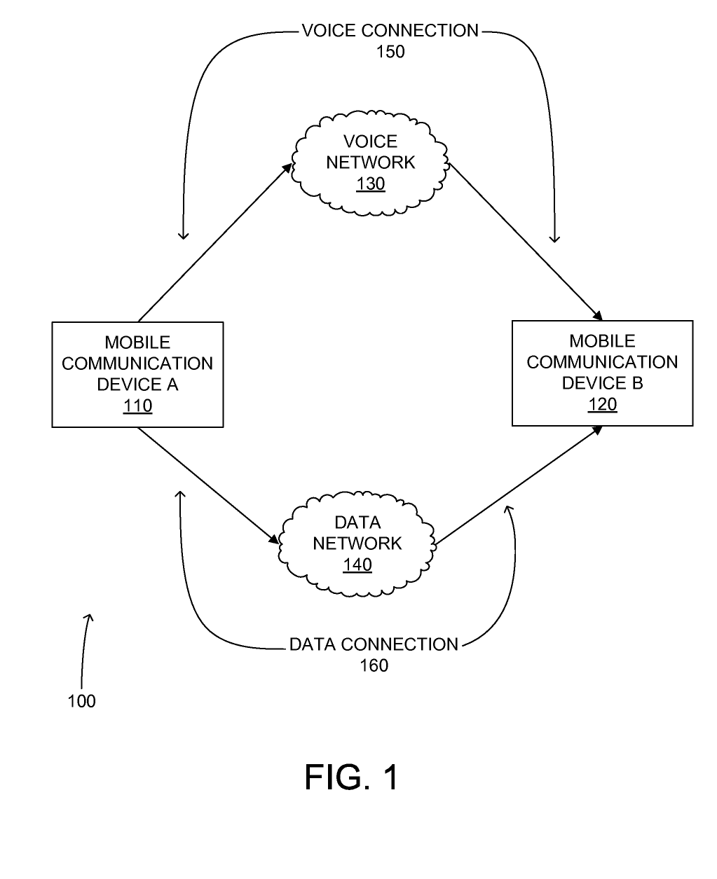

FIG. 1 illustrates one embodiment of a system 100 for transmitting voice information and data information from a mobile communication device to another mobile communication device. The system 100 comprises mobile communication device A 110, mobile communication device B 120, a voice network 130, a data network 140, a voice connection 150 and a data connection 160. Mobile communication device A 110 and mobile communication device B 120 may be compact portable devices able to transmit data and establish voice connections, certain embodiments of which are describe in more detail below.

A voice connection 150 may be established between mobile communication device A 110 and mobile communication device B 120. In one embodiment, mobile communication device A 110 transmits a signal to establish a voice connection 150 to a network service provider. The network service provider then establishes a voice connection 150 between mobile device A 110 and mobile device B 110 in response to this request.

The voice connection 150 may be used to exchange voice information, such as a telephone conversation, between mobile communication device A and mobile communication device B. In one embodiment, the voice connection 150 is established using a voice network 130. The voice network 130 may be a cellular telephone network, such as code division multiple access (CDMA), global system for mobile communications (GSM), general packet radio service (GPRS), or any network allowing for communication over a broad area.

The data connection 160 may be used to transmit data between mobile communication device A 110 and mobile communication device B 120. In an embodiment, the data connection 160 may be established using a data network 140. To establish the data connection 160, in one embodiment, mobile communication device A 110 transmits a signal to establish a data connection 160 to a network service provider. The network service provider then establishes a data connection 160 between mobile communication device A 110 and mobile communication device B 120. The data network 140 may be a conventional wireless data communication system, for example, general packet radio service (GPRS), IEEE 802.11 (or WiFi), or IEEE 802.16 (or WiMax), or any other suitable data communication system.

### System Operation

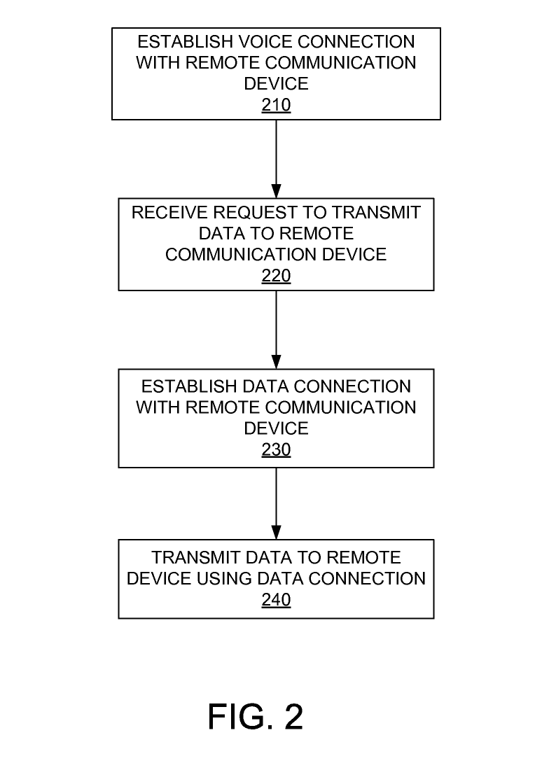

FIG. 2 is a flow chart illustrating the transmission of data from mobile communication device A 110 to mobile communication device B 120 according to one embodiment. Those of skill in the art will recognize that other embodiments can perform the steps of FIG. 2 in different orders. Moreover, other embodiments can include different and/or additional steps than the ones described here.

Mobile communication device A 110 establishes 210 a voice connection 150 with remote mobile device B 120. In one embodiment, mobile communication device A 110 establishes 210 the voice connection 150 by transmitting requesting a voice connection 150 a signal to a network service provider. In response, the network service provider creates a voice connection 150 between mobile communication device A 110 and mobile communication device B 120 in response to the signal. The voice connection 150 may be a voice call.

With the voice connection 150 established, mobile communication device A 110 receives 220 a request to transmit data from mobile communication device A 110 to mobile communication device B 120. This request may be received from a user via an input (e.g., a key press) into mobile communication device A 110. This may occur, for example, if a user of mobile communication device A 110 wants to share data on mobile communication device A 110. The user of mobile communication device A 110 may be navigating the mobile communication device A 110 and find data, such as a document, a photograph, or recorded video, to share with the user of remote mobile communication device B 120. Alternatively, the user of mobile communication device A 110 may wish to share a video stream, such as the video captured by a camera within or coupled to the device 110. In one embodiment, the user of mobile communication device A 110 may request to share data displayed on the mobile communication device A 110 during the voice connection 150.

After receiving 220 the request to transmit data to mobile communication device B 120, mobile communication device A 110 establishes 230 a data connection 160 between mobile communication device A 110 and mobile communication device B 120. In one embodiment, mobile communication device A 110 establishes 230 the data connection 160 by transmitting a signal requesting a data connection 160 to a network service provider. The network service provider then creates a data connection 160 between mobile communication device A 110 and mobile communication device B 120. In one embodiment, the data connection 160 created is a separate connection from the voice connection 150 established.

Once data connection 160 is established, mobile communication device A 110 transmits 240 data to mobile communication device B 120 using the data connection 160. As mobile communication device A 110 transmits 240 data to mobile communication device B 120 using the data connection 160, the voice connection 210 between mobile communication device A 110 and mobile communication device B 120 remains open. This allows voice transmissions between mobile communication device A 110 and mobile communication device B 120 to continue uninterrupted over the voice connection 150 while data are sent from mobile communication device A 110 to mobile communication device B 120 using the data connection 160.

With the data connection 160 established, the mobile communication device A 110 can transmit various types of data to mobile communication device B 120. For example, the data transmitted can be a video stream, a stored image, a file, contact information, or any data stored in mobile communication device A 110. In an embodiment, the data transmitted comprise or are otherwise related to information displayed on mobile communication device A 110 when voice connection 150 is established.

### Establishing the Data Connection

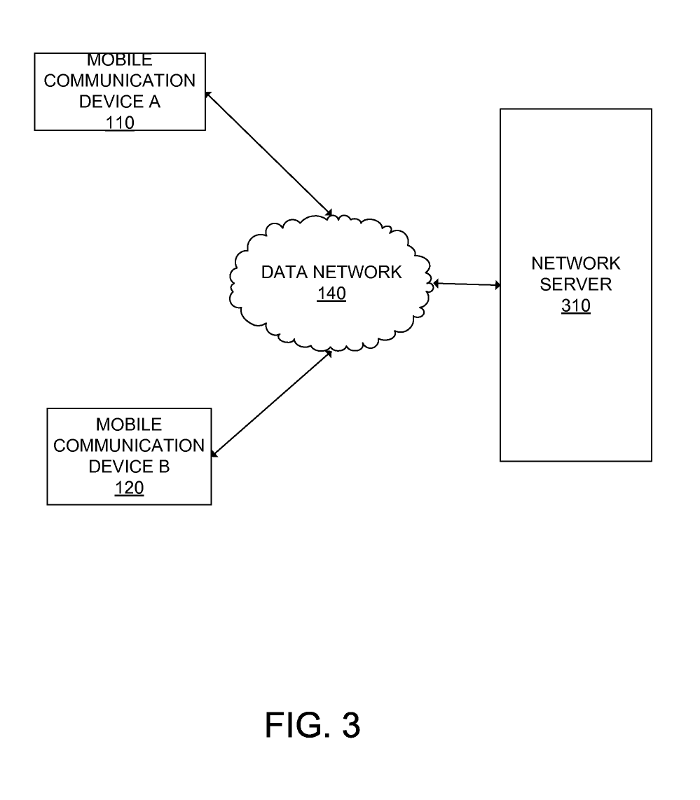

FIG. 3 is a block diagram illustrating one embodiment of a network configuration for allowing data transmission between mobile communication devices. Those of skill in the art will recognize that other embodiments can have different configurations than the ones described here.

As shown in FIG. 3, mobile communication device A 110 and mobile communication device B 120 access a network server 310 through a data network 140. The network server 310 contains information that can be used to identify and access the mobile communication devices connected to the data network 140, such as an Internet protocol (IP) address or other network address. In an embodiment, network server 310 contains a network address associated with mobile communication device A 110 and a different network address associated with mobile communication device B 120.

Network server 310 may store the information that identifies mobile communication device A 110 and mobile communication device B 120 using a variety of storage configurations. In one embodiment, network server 310 stores a network address associated with each mobile communication device that logs into the network server 310. Mobile communication devices typically receive a network address from a service provider that provides data services for the device. Network server 310 stores the network address assigned to the mobile communication device along with data that identifies the mobile communication device associated with the assigned network address. For example, the data identifying a mobile communication device may include the phone number of the mobile communication device.

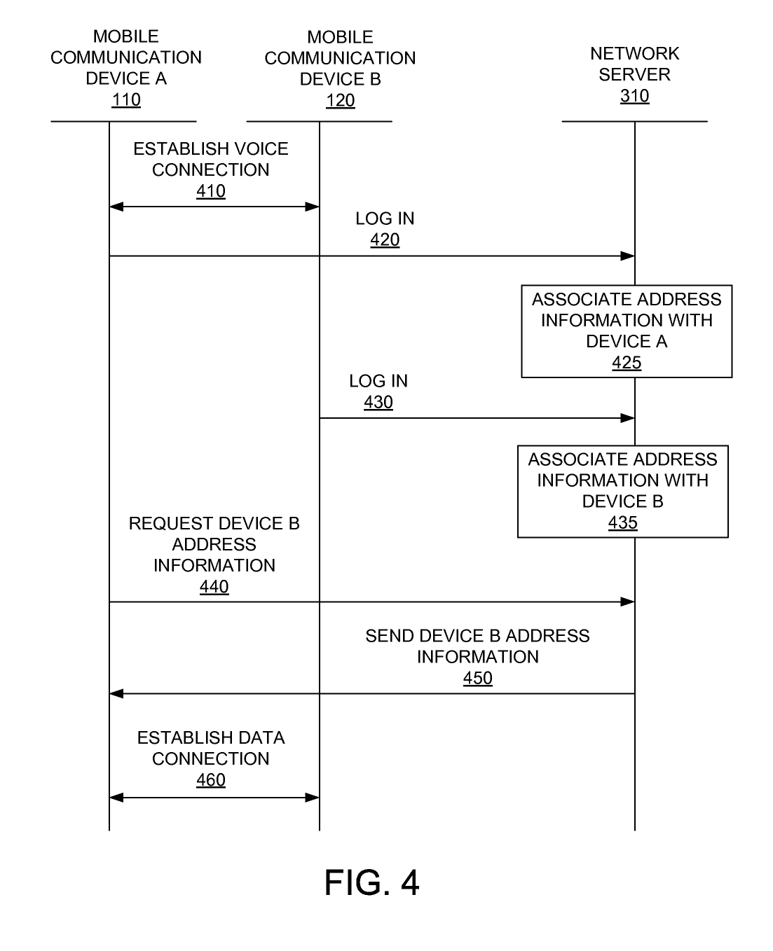

FIG. 4 is a trace diagram illustrating establishment of a data connection between mobile devices, in accordance with one embodiment of the invention. As illustrated, mobile communication device A 110 establishes 410 a voice connection 150 with mobile communication device B 120, for example, by transmitting a signal to a network service provider requesting the voice connection 150. Before or after establishing 410 the voice connection 150, mobile communication device A 110 logs into 420 the network server 310. The network server 310 associates 425 address information with mobile communication device A 110. Mobile communication device B 120 also logs into 430 the network server 310, which associates 435 the address information of mobile communication device B 120 with that device. As described above, network server 310 may associate each device's address information with a unique identifier associated with that device, such as a phone number for the device.

After mobile communication device A 110 and mobile communication device B 120 have provided their network addresses to the network server 310, mobile communication device A 110 may request 440 address information associated with mobile communication device B 120 from the network server 310. Mobile communication device A 110 requests 440 address information associated 435 with mobile communication device B 120 when the user of mobile communication device A 110 wants to share data with mobile communication device B 120. In one embodiment, the address information associated with mobile communication device B 120 is a network address, such as an IP address, that can be used to access mobile communication device B 120 through the data network 140.

The network server 310 then sends 450 the address information associated with mobile communication device B 120 to mobile communication device A 110. Mobile communication device A 110 can use this address information for mobile communication device B 120 to establish 460 a data connection 160 with mobile communication device B 120, for example, by transmitting a signal to a network service provider requesting a data connection 160 with mobile communication device B 120. The network service provider then enables the data connection 160 between mobile communication device A 110 and mobile communication device B 120.

In an alternate embodiment, a data connection 160 between mobile communication device A 110 and mobile communication device B 120 is established 410 before the voice connection 150 is established 460. For example, mobile communication device A 110 and mobile communication device B 120 might already be exchanging data when a user elects to establish a voice call between the devices. Regardless of which connection was first established, both the data connection 160 and the voice connection 150 can be maintained simultaneously.

In another embodiment of the invention, mobile communication device A 110 is pre-assigned address information associated with mobile communication device A 110. Similarly, mobile communication device B 120 is pre-assigned address information associated with mobile communication device B 120. For example, mobile communication device A 110 and mobile communication device B 120 can each be assigned a static IP address. In this embodiment, network server 310 can correlate the address information associated with each mobile communication device with the corresponding mobile communication device. For example, the network server 310 may maintain a database that correlates the address information associated with mobile communication device A 110 with a data that identifies mobile communication device A 110, such as the phone number of mobile communication device A 110 or serial number of mobile communication device A 110. In this embodiment, mobile communication device A 110 can request address information associated with mobile communication device B 120 from network server 310 without first logging into 420 the network server 310.

In yet another embodiment, if the network server 310 does not contain address information associated with mobile communication device B 120, the network server 310 can function as a messaging server able to transmit text messages, multimedia messages, email, or other message types. This allows mobile communication device A 110 to transmit the data to mobile communication device B 120 using a message if network server 310 does not contain address information associated with mobile communication device B 120. This embodiment allows mobile communication devices that are incompatible with the primary sharing method, such as legacy devices or devices using a different operating environment, to share data. In this way, a broader range of mobile communication devices may work with embodiments of the invention described herein.

Additionally, this embodiment allows the network server 310 to route data from mobile communication device A 110 to mobile communication device B 120 if a data connection 160 cannot be established 460 between mobile communication device A 110 and mobile communication device B 120. This allows data to be exchanged between mobile communication device A 110 and mobile communication device B 120 without altering the format of the data to be exchanged. In another embodiment, if a data connection 160 cannot be established 460, network server 310 stores the data from mobile communication device A 110 in a queue. Network server 310 then transmits the contents of the queue to mobile communication device B 120 after a data connection 160 is established 460.

In one embodiment, mobile communication device A 110 creates a text message, multimedia message, email message, or another message type containing the data to be transmitted to mobile communication device B 120. Mobile communication device A 110 then transmits the message to network server 310. After receiving the message, network server 310 uses the phone number of mobile communication device B 120 to notify mobile communication device B 120 of the message. Mobile communication device B 120 is then able to access the message containing the data from mobile communication device A 110 from network server 310.

In an alternative embodiment, mobile communication device A 110 transmits to network server 310 a link to a network location containing the data to be transmitted to mobile communication device B 120. Network server 310 then uses the phone number of mobile communication device B 120 to transmit the link to the network location to mobile communication device B 120. Mobile communication device B 120 is then able to access the data from mobile communication device A 110 by accessing the network location specified in the link form network server 310.

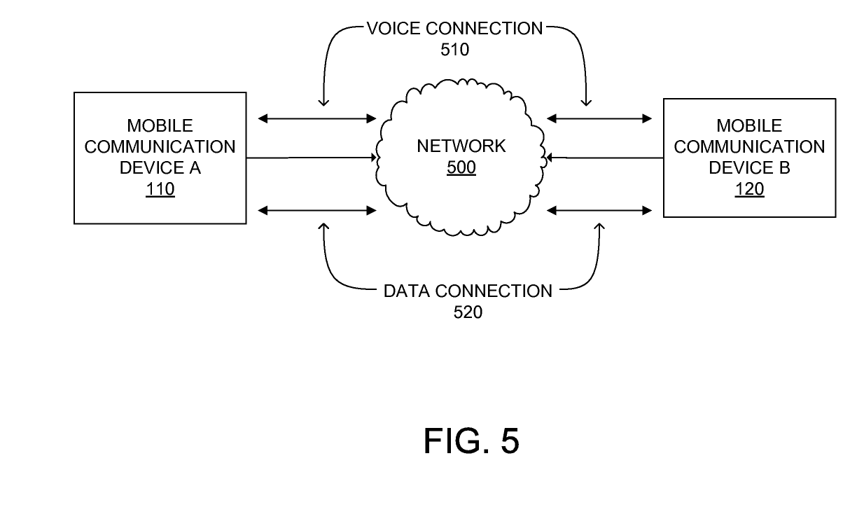

FIG. 5 is a block diagram illustrating an alternative embodiment of a system 100 for transmitting voice information and data information from a mobile communication device to another mobile communication device. FIG. 5 illustrates mobile communication device A 110, mobile communication device B 120, a network 500, a voice connection 510, and a data connection 520. In this embodiment, network 500 is capable of establishing both a voice connection 510 and a data connection 520 over the single network 500. For example, network 500 can be an IP network where the voice connection 510 is a voice over IP (VoIP) connection and the data connection 520 is an IP connection.

Network 500 permits mobile communication device A 110 to establish both a voice connection 150 and a data connection 160 with mobile communication device B 120. For example, network 500 permits mobile communication device A 110 to transmit signals to a network service provider requesting establishment of a voice connection 150 and/or a data connection 160 with mobile communication device B 120. In an embodiment, mobile communication device A 110 can simultaneously transmit voice information and data to mobile communication device B 120 using a single network 500. When a single network 500 is used for the voice connection 510 and data connection 520, each mobile communication device recognizes the network address of the other mobile communication devices using the network 510. For example, when network 510 is used, mobile communication device A 110 recognizes the network address of mobile communication device B 120 once both devices access network 510; thus, mobile communication device A 110 can transmit data to mobile communication device B 120.

Those of skill in the art will recognize that the above described embodiments are merely illustrative and that other embodiments can achieve the same result including different and/or additional designs than the ones described here.

### User Interface

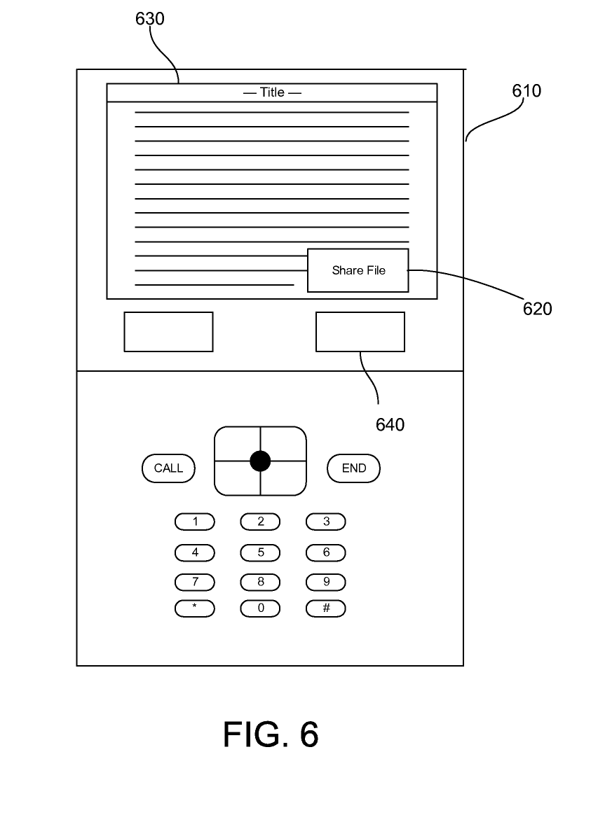

As described above, data may be shared from mobile communication device A 110 to mobile communication device B 120 in response to user interaction with mobile communication device A 110. FIG. 6 illustrates one embodiment of a user interface to transmit information from a user of mobile communication device A 110. Those of skill in the art will recognize that different embodiments can provide the information and functionality of FIG. 6 in different ways. Moreover, other embodiments can include different and/or additional features and/or layouts than the ones described here.

In one embodiment, the display area 610 of a local mobile communication device displays a document 630 stored in the mobile communication device or accessed by the mobile communication device. The display of the document 630 may be accessed according to the standard user interface functionality for the device. If a voice call is being made when the document 630 is being accessed, a prompt 620 is also displayed to allow the user to transmit the document 630 to a remote mobile communication device. Alternatively, if the mobile communication device establishes a voice connection with a remote mobile communication device while the document 630 is being accessed, the prompt 620 may also be displayed.

Prompt 620 enables the user of the local mobile communication device to transmit the displayed document 630 to the remote mobile communication device. The prompt 620 to the user of the local mobile communication device can be, for example, a virtual or “soft” button, an icon, or highlighted text. The document 630 that is displayed can be, for example, a spreadsheet, a text file, a web page, or other file types containing textual information. The document 630 can be physically stored in the local mobile communication device or can be accessed by the local mobile communication device.

A user of the local mobile communication device may elect to share the document 630 by selecting the prompt 620. Prompt 620 may be selected in a variety of ways. In one embodiment, the user presses a physical button 640 on the local mobile communication device that is positioned near the display area 610, for example where prompt 620 is a virtual or “soft” button. In another embodiment, the user taps the display area 610 in the location where prompt 620 is displayed. In an alternative embodiment, a physical button 640 is dedicated to transmitting the contents of the display area 610. Thus, depressing the physical button 640 transmits the contents of the display area 610, including the document 630 being viewed, to the remote mobile communication device. Depressing the physical button 640 when no document 630 is being viewed can result in transmission of information associated with the contents of display area 610.

A user selection of prompt 620 causes the local mobile communication device to transmit the document 630 that is being viewed to the remote mobile communication device with which the local mobile communication is currently in a voice call. This transfer may be done according to any of the methods described herein.

If the voice connection between the local mobile communication device and the remote mobile communication device is interrupted or otherwise terminates, the prompt 620 may no longer be displayed in display area 610. In this way, when the voice call between the local mobile communication device and the remote mobile communication device ends, the opportunity to share data between the mobile communication devices using this mechanism likewise ends.

The document being shared may comprise any of a variety of types of documents or other information used by software on a mobile device. For example, the document may comprise a text file, a graphical file, an email, a spreadsheet, or any other information that a user may display on the device and wish to transfer to the person to which the user is speaking. The document being transferred may also be an electronic card or otherwise contain contact information. For example, while talking to someone on the phone, a user may navigate a contacts application or electronic rolodex to select and transmit the contact information for a third party to the person to which the user is speaking. It can be appreciated that a variety of uses are enabled by this embodiment, in which a user can share any information stored on the device, or accessible by the device, with the other party on a phone call.

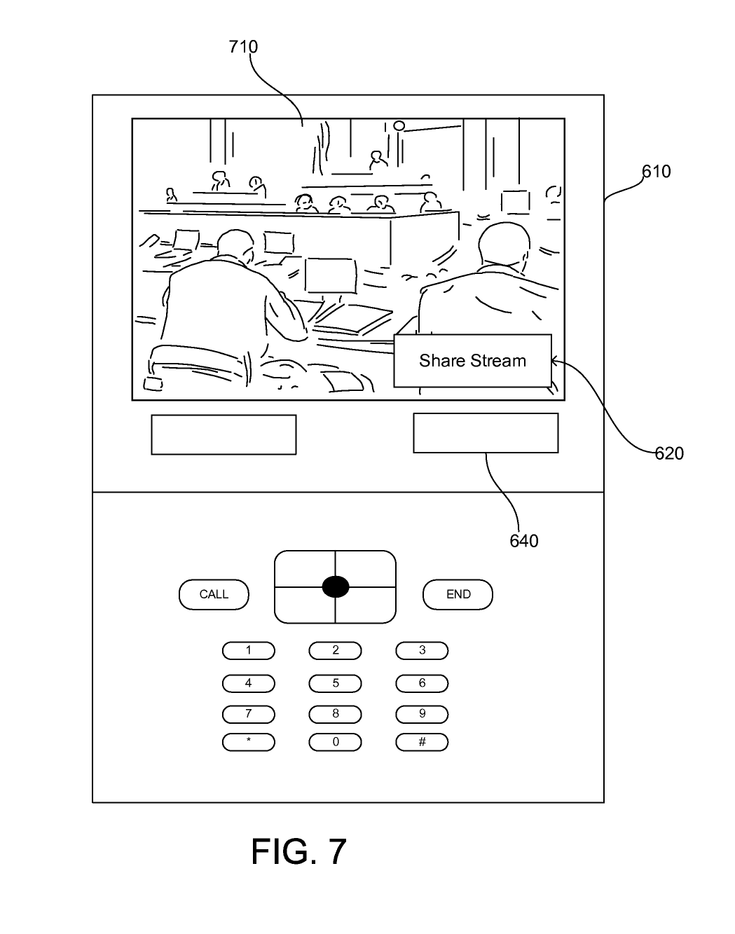

FIG. 7 illustrates another embodiment of a user interface for transmitting multimedia content from a local mobile communication device to a remote mobile communication device during a voice call. Those of skill in the art will recognize that different embodiments can provide the information and functionality of FIG. 7 in different ways. Moreover, other embodiments can include different and/or additional features and/or layouts than the ones described here.

In this embodiment, the display area 610 of the local mobile communication device displays multimedia content 710 stored in the mobile communication device. Multimedia content 710 can be many types of content, for example video data, graphical data, audio data, contact data. In one embodiment, the multimedia content 710 comprises a stored video capture from a camera or video recorder included in the local mobile communication device or coupled thereto. In another embodiment, the multimedia content 710 comprises a video stream, such as the video captured by a camera or video reordered within or coupled to the mobile communication device. Once the local mobile communication device establishes a voice connection with the remote mobile communication device, the display area 610 of the local mobile communication device displays a prompt 620 to the user of the local mobile communication device. The prompt 620 allows the user to share the multimedia content 710 with the other party on the voice call.

In one embodiment, the quality of the shared multimedia content 710 is degraded in response to the bandwidth available to transmit the multimedia content 710. This allows the multimedia content 710 to be shared between devices while conserving network resources.

FIG. 7 illustrates how a similar user interface can be used to transmit both documents 630 and multimedia content 710. The transmission of the multimedia content 710 from the local mobile communication device to the remote communication device proceeds in the manner described above with regard to FIG. 6.

### Mobile Communication Device

A mobile communication device a type of device that is structured to fit, and be controlled from, a palm of a hand and combines computing capabilities with wireless communication capabilities, such as cellular (or mobile) telephone capabilities. Example form factors include cordless telephones, mobile (or cellular) telephones, personal digital assistants (PDAs), and personal communicators (e.g., a TREO® Smartphone from Palm, Inc. (Sunnyvale, Calif.)). The front of the mobile communication device may include a display area and several physical buttons.

The display area includes a visual display device, such as a liquid crystal display for presenting information to the user. A user may manipulate the physical buttons to input information into the mobile communication device and make selections of information presented on the display area. In an embodiment, the display area may also be covered with a digitizer pad that allows the user to enter information into the mobile communication device using, e.g., a stylus or a finger. The digitizer pad may also be referenced as a “touch” sensitive display (e.g., pressure-sensitive (resistive), electrically-sensitive (capacitance), acoustically-sensitive (SAW—surface acoustic wave), or photo-sensitive (infra-red)) and can be interacted with accordingly.

In operation of an embodiment, the display area displays information to the user of the mobile communication device. The user is then able to employ, e.g., a stylus, a finger, or inductive pen, to manipulate and interact with the displayed information by touching the digitizer pad overlaid on top of the display device. In one mode of operation, a stylus can be used in the manner of a writing pen to enter characters and figures by drawing the stylus across the digitizer pad.

In one embodiment, the user is instructed to enter text into a specific area of the digitizer pad. The stylus and digitizer may function like a computer mouse to operate and manipulate interactive elements on the display. For example, the computer system may present a virtual button in a location on the display that can be activated to perform an associated function by the user tapping the stylus or a finger on the digitizer pad at the virtual button location, or by pressing a physical button located near the virtual display device. The stylus can also be used to perform “drag and drop” operations in the fashion known in the use of a computer mouse.

The mobile communication device may also include a keyboard or digit dial pad area such that the user may enter information such as names, addresses, phone numbers, email messages and text messages into application programs running on the mobile communication device. Additionally, the keyboard or digit dial pad allows the user to dial telephone numbers to create voice connections between multiple mobile communication devices using the wireless communication capabilities of the mobile communication device. This allows the exchange of voice information between mobile communication devices.

Also, the mobile communication device may include a cellular telephone transceiver and circuitry for enabling communications with a voice network, such as a cellular telephone network. The mobile communication device may also include circuitry to enable communication with a data network. The data network can be a conventional wireless data communication system, for example, general packet radio service (GPRS), IEEE 802.11b/a/g/n (or WiFi), or IEEE 802.16 (or WiMax).

The above description provides examples of common devices and the invention need not be limited for use with these specifically described devices.

### SUMMARY

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system or similar electronic computing device, which manipulates and transforms data represented as physical (electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memory (ROM), random access memory (RAM), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims.

What is claimed is:

1. A computer program product for communicating data between a local mobile communication device and a remote mobile communication device, the computer program product comprising a computer-readable medium containing computer program code for:
transmitting a signal to establish a voice connection between the local mobile communication device and the remote mobile communication device;
receiving, at the local mobile communication device, a user command to communicate data from the local mobile communication device to the remote mobile communication device; and
transmitting the data from the local mobile communication device to the remote mobile communication device while maintaining the voice connection.

2. The computer program product of claim 1, wherein transmitting the data from the local mobile communication device to the remote communication device while maintaining the voice connection comprises:
transmitting a signal to establish a data connection between the local mobile communication device and the remote mobile communication device in response to the user command; and
transmitting the data from the local mobile communication device to the remote mobile communication device using the established data connection.

3. The computer program product of claim 2, wherein transmitting a signal to establish the data connection comprises:
requesting from a network server a network address of the remote device;
receiving from the network server the network address of the remote device; and
communicating with the remote device using the network address of the remote device received from the network server.

4. The computer program product of claim 1, wherein the transmitted data are associated with information displayed on a display of the local mobile communication device.

5. The computer program product of claim 1, wherein the transmitted data comprise information selected from a group consisting of: electronic documents, photographs, web pages, spreadsheets, text files, video, audio, contact information, calendar information, and screen captures.

6. The computer program product of claim 1, wherein the transmitted data comprise a video stream captured from a camera associated with the local mobile communication device.

7. The computer program product of claim 1, wherein receiving the user command to transmit data comprises:
displaying data on the local mobile communication device;
displaying a prompt on the local mobile communication device to share the data; and
receiving a selection by a user of the prompt.

8. The computer program product of claim 7, wherein the prompt is a virtual button displayed on a display of the local mobile communication device.

9. The computer program product of claim 1, wherein transmitting the data from the local mobile communication device to the remote mobile communication device comprises:
creating a message containing the data from the local mobile communication device if the remote mobile communication device is unavailable; and
sending the created message to the remote mobile communication device.

10. The computer program product of claim 1, wherein transmitting the data from the local mobile communication device to the remote mobile communication device comprises:
transmitting the data to a network server, wherein the network server transmits the data to the remote mobile communication device.

11. The computer program product of claim 1, wherein transmitting the data from the local mobile communication device to the remote mobile communication device comprises:
transmitting the data to a network storage location;
transmitting a link to the network storage location to the remote mobile communication device.

12. The computer program product of claim 1, wherein transmitting the data from the local mobile communication device to the remote mobile communication device comprises:
storing the data from the local mobile communication device in a queue if the remote mobile communication device is unavailable; and
transmitting the queue to the remote mobile communication device in response to the mobile communication device becoming available.

13. The computer program product of claim 2, wherein the voice and data connections are established on different networks.

14. The computer program product of claim 2, wherein the voice and data connections are established on the same network.

15. The computer program product of claim 14, wherein the network is an Internet Protocol network.

16. A mobile communication device comprising:
a display module;
an input module;
a transceiver adapted to transmit signals to establish a voice connection and a data connection with a remote mobile communication device over one or more communication networks; and
a processor configured to transmit data to a remote mobile communication device responsive to a user command received via the input module, the user command received and the data transmitted while the mobile communication device maintains a voice connection with the remote mobile communication device.

17. The mobile communication device of claim 16, wherein the data are associated with information displayed on the display module.

18. The mobile communication device of claim 16, wherein the data comprise information selected from a group consisting of: an electronic document, a spreadsheet, a web page, a text file, a picture, a video file, an audio file, contact information, calendar information, and a screen capture.

19. The mobile communication device of claim 16, wherein the data comprise a video stream captured from a camera associated with the mobile communication device.

20. The mobile communication device of claim 16, wherein the input module comprises a virtual button.

21. The mobile communication device of claim 16, wherein the input module comprises a dedicated physical button.

22. The mobile communication device of claim 16, wherein the transceiver is adapted to transmit signals to establish a data connection that is different than a voice connection.

23. A system for communicating data between mobile communication devices, the system comprising:
a voice network for allowing voice connections between mobile communication devices;
a data network for allowing data connections between the mobile communication devices; and
a plurality of mobile communication devices coupled to the data and voice networks, each mobile communication device as claimed in claim 16.

24. The system of claim 23, further comprising:
a network server, accessible by the mobile communication devices, for associating a network address with each of the mobile communication devices.

25. The system of claim 24, wherein the network server is configured to create a message containing the data from each mobile communication device if the mobile communication device with which the voice connection is established is unable to receive data, and further configured to send the created message to the mobile communication device with which the voice connection is established.

26. The system of claim 25, wherein the message is selected from a group consisting of: a text message, a multimedia message, and an email message.

27. The system of claim 23, wherein the network server is configured to create a queue containing the data from a mobile communication device seeking to transmit data and then transmit the data according to the queue.

28. The system of claim 23, wherein the voice and data networks are implemented by an Internet Protocol network.

29. A system for communicating data between mobile communication devices, the system comprising:
a first mobile communication device for communicating over a voice connection;
a second mobile communication device for communicating over a voice connection; and
means for sharing data between the first mobile communication device and the second mobile communication while maintaining the voice connection.

30. The system of claim 29, further comprising:
means for associating a first network address with the first mobile communication device and associating a second network address with the second mobile communication device.

31. A computer program product for communicating data from a local mobile communication device to a remote mobile communication device, the computer program product comprising a computer-readable medium containing computer program code for:
transmitting a signal to establish a voice connection between the local mobile communication device and the remote mobile communication device;
receiving a command to access data by the local mobile communication device;
responsive to accessing the data when a voice connection is established, presenting an option to transmit the data to the remote mobile communication device; and
responsive to a selection of the option to transmit the data, transmitting the data to the remote mobile communication device while maintaining the voice connection.

32. The computer program product of claim 31, wherein the data comprise information selected from a group consisting of: an electronic document, a spreadsheet, a web page, a text file, a picture, a video file, an audio file, contact information, calendar information, and a screen capture.

33. The computer program product of claim 31, wherein the data comprise a video stream captured from a camera associated with the local mobile communication device.
